(19) United States
(12) Patent Application Publication
(10) Pub. No.: US 2026/0247076 A1
(43) Pub. Date: Aug. 20, 2026

(54) BASS LOUDSPEAKER

(71) Applicant: PSS BELGIUM NV, Dendermonde (BE)

(72) Inventor: Fabian VUINE, Mechelen (BE)

(21) Appl. No.: 18/876,687

(22) PCT Filed: Jun. 27, 2023
(86) PCT No.: PCT/EP2023/067426

§ 371 Date: Dec. 19, 2024

(30) Foreign Application Priority Data
Jun. 29, 2022 (GB) 2209544.2

(51) Int. Cl. H04R 9/02; H04R 1/06; H04R 7/12; H04R 7/18; H04R 9/06

(52) U.S. Cl. CPC H04R 9/025; H04R 1/06; H04R 7/122; H04R 7/18; H04R 9/06; H04R 2400/11; H04R 2499/13

(57) ABSTRACT

A bass loudspeaker including: a frame; a diaphragm suspended by first and second suspension elements; the first and second suspension elements attached to the frame at first and second landing surfaces, respectively; a magnet unit secured to the frame; the magnet unit includes a magnet and flux guiding elements guide magnetic flux across an air gap; a voice coil rigidly connected to the diaphragm; the loudspeaker energises the voice coil to cause it to move relative to the magnet unit along a movement axis, thereby moving the diaphragm along the axis to produce sound; the voice coil configured to sit in the gap, with a centre of mass positioned along the axis between the first and second landing surfaces, when the diaphragm is at rest; a magnetic flux density at an outer perimeter of the voice coil is 50% or less of a magnetic flux density at an inner perimeter.

This application claims priority to GB2209544.2, filed 29 Jun. 2022.

### FIELD OF THE INVENTION

The present invention relates to a bass loudspeaker including a frame, a diaphragm and a drive unit.

### BACKGROUND

A typical conventional loudspeaker has a frame, a diaphragm and a drive unit for the reproduction of sound. In use, the drive unit causes the diaphragm, which acts as a piston, to move backwards and forwards to generate pressure waves, i.e. sound.

The drive unit typically includes a magnet unit attached to the frame and a voice coil attached to the diaphragm. The magnet unit defines a magnetic circuit including an air gap across which magnetic flux is guided and in which the voice coil sits when at rest. By energising the voice coil, the magnet unit and the voice coil magnetically cooperate, i.e. magnetically interact, with each other to effect displacement of the combination of the voice coil and the diaphragm to thereby produce sound.

The present inventor has observed that, in accordance with conventional principles, in order to make efficient use of the magnetic circuit when the loudspeaker is in operation, the magnet unit generates the magnetic flux in the air gap such that the associated magnetic flux density is as uniform as possible across said air gap. For example, for small bass loudspeakers, the magnetic flux density is desired to be as uniform as possible across the air gap in order to ensure efficient use of the magnetic circuit, since for these loudspeakers the mass and size of the voice coil may be kept comparatively to inhibit rocking. Thus, in conventional loudspeakers the magnetic flux density may typically drop from an initial 100% to a value of 90%, or maybe as low as 85%, across the voice coil in the air gap.

### SUMMARY OF THE INVENTION

Herein is described a bass loudspeaker that may be viewed as departing from the conventional principles outlined in the background section above. More particularly, the described bass loudspeaker has an air gap wherein the magnetic flux density across the voice coil drops significantly, by 50% or more. The described bass loudspeaker further has improved rocking resistance, which allows for a greater range of voice coil parameters, particularly comparatively large/heavy voice coils, to achieve desired performance of the loudspeaker.

According to a first aspect of the invention, there is provided a bass loudspeaker including a frame; a diaphragm suspended from the frame by at least a first suspension element and a second suspension element, wherein the first suspension element is attached to the frame at a first landing surface on the frame and the second suspension element is attached to the frame at a second landing surface on the frame; a magnet unit secured to the frame, wherein the magnet unit includes a permanent magnet and at least two flux guiding elements configured to guide magnetic flux across an air gap; a voice coil rigidly connected to the diaphragm; wherein the loudspeaker is operable to energise the voice coil to cause the voice coil to move relative to the magnet unit along a movement axis, thereby moving the diaphragm along the movement axis to produce sound; wherein the voice coil is configured to sit in the air gap, with a centre of mass of the voice coil having a position along the movement axis that is between the first landing surface and the second landing surface, when the diaphragm is at rest; and wherein a magnetic flux density at an outer perimeter of the voice coil is 50% (percent) or less of a magnetic flux density at an inner perimeter of the voice coil.

By having a magnetic flux density at an outer perimeter of the voice coil is 50% (percent) or less of a magnetic flux density at an inner perimeter of the voice coil, the loudspeaker is able to have a magnet unit which is smaller or lighter, thereby facilitating a lighter overall loudspeaker (even if the coil is made heavier to compensate). By arranging the voice coil and the suspension elements such that the centre of gravity of the voice coil is located between the first landing surface and the second landing surface, rocking (e.g. as caused by having a heavier coil to compensate for reduced flux across the air gap) may be inhibited. More particularly, the rocking modes of the loudspeaker may be pushed outside of the working frequency range of the loudspeaker. As a result, voice coil, e.g. size/weight, may be selected to compensate for the drop in magnetic flux density without compromising desired performance, e.g. force factor.

The bass loudspeaker as described above may be configured to produce sound with frequencies in a bass frequency range. The bass frequency range may include 60-80 Hz, where “Hz” represents the physical unit “Hertz”. More preferably, the bass frequency range may include 40-100 Hz. By way of example, the bass frequency range may be 20 Hz-100 Hz.

The first suspension element may be provided as a surround. The first suspension element may attach directly or indirectly to the diaphragm. In some examples, the first suspension element may be secured to an outer edge of the diaphragm.

The second suspension element may be provided as a damper (which may be referred to as a “spider”). The second suspension element may attach directly or indirectly to the diaphragm. In some examples, the second suspension element may be secured to the diaphragm at a location inwardly located with respect to the outer edge of the diaphragm.

The voice coil is rigidly connected to the diaphragm such that the diaphragm and the voice coil move together (e.g. “as one”) along the movement axis when the loudspeaker is energised. The voice coil may be rigidly connected to the diaphragm directly or indirectly.

The magnetic flux density in the air gap as referenced herein may be a radial magnetic flux density. The radial magnetic flux density may be a magnetic flux density as measured in a direction perpendicular to the movement axis.

If the voice coil is generally circular, the inner perimeter of the voice coil may be referred to as the inner diameter of the voice coil, and the outer perimeter of the voice coil may be referred to as the outer diameter of the voice coil.

A distance between the inner perimeter and outer perimeter in a radial direction (i.e. in a direction perpendicular to the movement axis) may be taken as a winding thickness of the voice coil. Accordingly, the magnetic flux density permeating the voice coil may drop over the winding thickness of the voice coil as specified above.

The extent to which the magnetic flux density drops (by 50% or more) across the voice coil may depend on design considerations, which may vary from loudspeaker to loudspeaker. In most cases, it is thought that the drop may be up to 90%, or even higher. If the drop is up to 90%, then the magnetic flux density at the outer perimeter of the voice coil may be in a range of 10% to 50% of the magnetic flux density at the inner perimeter of the voice coil.

The at least two flux guiding elements may define the air gap as a volume of space between the at least two flux guiding elements. When the diaphragm is at rest such that the voice coil sits in the air gap, the voice coil may be located between the at least two flux guiding elements.

The at least two flux guiding elements may include a washer and may include a yoke, optionally provided as a U-yoke. The permanent magnet may be located between the washer and the yoke.

The yoke may include a base and a sidewall extending from the base. The washer and the yoke may be arranged to define the air gap between the washer and a sidewall of the yoke.

A thickness of the sidewall of the yoke in a direction perpendicular to the movement axis may be smaller than a thickness of the voice coil in the direction perpendicular to the movement axis. Where the sidewall has a uniform wall thickness (in the direction perpendicular to the movement axis), the thickness of the voice coil (in the direction perpendicular to the movement axis) may be greater than the (uniform) wall thickness. Where the sidewall has a non-uniform wall thickness, the maximal value of the (non-uniform) wall thickness (in the direction perpendicular to the movement axis) may be smaller than the thickness of the voice coil (in the direction perpendicular to the movement axis).

The thickness of the sidewall (e.g. as defined above) may be smaller than the thickness of the voice coil by at least a factor of two, more preferably three, e.g. a factor of 3.15.

In some examples, the thickness of the sidewall (e.g. as defined above) may be smaller than the thickness of the voice coil by a factor of five or more.

An average magnetic flux density within the at least two flux guiding elements may be between 1.5 T and 2 T, where “T” represents the physical unit “Tesla”, e.g. to avoid/reduce problems caused by saturation of the flux guiding elements.

A separation between the first and second landing surfaces may be defined as a distance between a location on the first landing surface and a location on the second landing surface as measured in direction parallel to the movement axis.

An extent of the voice coil as measured in direction parallel to the movement axis (or ‘height’ of the voice coil) may be in a range of 85% and 100% of the separation between the first and second landing surfaces as measured in direction parallel to the movement axis. This configuration may enable large linear displacement of the voice coil while effectively inhibit rocking motion.

The magnet unit and the air gap may form a magnetic circuit. The magnetic circuit may provide a substantially closed circuit (or loop) for the magnetic flux that is generated by the permanent magnet and is guided by the at least two flux guiding elements.

The magnetic circuit may have a comparatively high magnetic reluctance. In particular, the magnetic reluctance may exceed the magnetic reluctance of a conventional magnet unit, which is typically kept low. For example, the magnetic reluctance of the magnetic circuit may be at least 2.5×10\hat{ }6[1/H] or even 3×10\hat{ }6[1/H], where “H” represents the physical unit “Henry”. By contrast, a conventional magnet unit may have a magnetic reluctance of at most 1.5×10\hat{ }6[1/H]. Thus, the magnetic reluctance according to the present disclosure corresponds to, or exceeds, 166% or even 200% of the magnetic reluctance of a more conventional magnetic unit.

The majority of the magnetic reluctance of the magnetic circuit may be attributed to the air gap. For example, the air gap may have a magnetic reluctance of at least 2×10\hat{ }6 [1/H].

By utilising a magnetic circuit with high magnetic reluctance, and particularly a high-reluctance air gap, it is possible to utilise comparatively small flux guiding elements. Thus, it is possible to reduce the weight of the magnet unit. This weight reduction of the magnet unit may more than compensate for the weight of a large voice coil, meaning that the comparatively high magnetic reluctance of the magnetic circuit enables designing of particularly lightweight loudspeakers. Such considerations may be relevant especially for applications in, for example, the automobile industry.

The permanent magnet may have a smaller mass than the mass of the voice coil. That is to say, the permanent magnet may have a first mass, the voice coil may have a second mass, and the first mass may be smaller than the second mass. The first mass may be smaller than the second mass by at least a factor of two, or even by at least a factor of 2.5, for example by a factor of 2.8.

In a conventional loudspeaker, the mass of the permanent magnet may be relatively large compared to the mass of the voice coil, for reasons outlined in the background section above. However, the present invention allows for a comparatively heavy, and hence large/dense, voice coil which may be combined with a smaller/lighter permanent magnet (and hence magnet unit). Accordingly, the combination of a smaller permanent magnet and a larger/denser voice coil may help to achieve desired performance parameters, whilst reducing weight of the loudspeaker and weight of the permanent magnet. In view of the increasing prices for rare earth magnets, this may provide for a more cost-effective configuration.

The diaphragm may comprise a first diaphragm body and a second diaphragm body which is centred with respect to the first diaphragm body (e.g. with respect to a movement axis). The first diaphragm body may also be referred to as an outer diaphragm body and the second diaphragm body may also be referred to as a central diaphragm body.

The outer diaphragm body and the central diaphragm body may be formed integrally. Alternatively, the outer diaphragm body and the central diaphragm body may be formed separately and joined together, e.g. using a suitable adhesive.

The outer diaphragm body may have a first radiating surface facing in a forward direction (e.g. away from the frame) and a second radiating surface facing in a rearward direction (e.g. towards the frame).

The central diaphragm body may include an annular wall which extends around the voice coil, the annular wall extending along the movement axis between a first end and a second end of the central diaphragm body. The first end may be further forwards along the movement axis than the second end. The outer diaphragm body may be connected to the annular wall at a location between the first end and the second end of the central diaphragm body, such that the second end of the annular wall is separated from the location where the outer diaphragm is connected to the annular wall.

The outer diaphragm body may be connected to the first suspension element, e.g. at an outer edge of the outer diaphragm body. The second suspension element may be connected to the annular wall at or towards the second end of the central diaphragm body.

The central diaphragm body may provide an improved structure for attaching a suspension element. In particular, the second end of the annular wall of the diaphragm body provides for a free end (i.e. the second end) extending away from the outer diaphragm body (in a rearward direction) and to this free end the suspension element may be attached. Thus, positioning of the suspension element may be improved and rocking inhibited.

Where the outer diaphragm body and the central diaphragm body are provided as separately formed bodies, this may provide an improved structure for purposes of assembly. In particular, this may facilitate improved installation of lead wires during assembly since the outer diaphragm body may be installed in a subsequent manufacturing step (i.e. after the central diaphragm body), thereby providing ease of access.

If the outer diaphragm body and the central diaphragm body are formed separately, these may be joined together by mating corresponding surfaces. For example, the outer diaphragm body may have an inner circumferential surface inclined relative to the movement axis, and the annular wall of the central diaphragm body may have an outer circumferential surface inclined relative to the movement axis. The inner circumferential surface and the outer circumferential surface may be inclined relative to the movement axis by substantially the same angle and secured together, e.g. using a suitable adhesive.

The or each angle may be in a range of 3 degrees and 35 degrees relative to the movement axis, preferably between 3 degrees and 20 degrees relative to the movement axis.

The indicated ranges of angles may improve joining of the outer diaphragm body and the central diaphragm body, where these are formed separately, and may improve positioning of the second end of the annular wall (where the annular wall is straight) for purposes of attaching the second suspension element.

The central diaphragm body may include a signal track to transmit an electrical signal to or from the voice coil. The signal track may extend from a location on the outer circumferential surface of the annular wall of the central diaphragm, along the annular wall and towards the voice coil. The location from which the signal track extends may be at or towards the second end of the annular wall. A first solder pad may be provided on the central diaphragm body at the location from which the signal track extends. Here, ‘at or towards the second end of the annular wall’ may be understood to mean that this location is at the second end of the annular wall or between the second end and where the outer diaphragm body attaches to the annular wall.

In some examples, the signal track may extend to a second solder pad on a wall of the central diaphragm body which is proximate to the voice coil, e.g. to facilitate easy connection of the signal track to the voice coil. This second solder pad may be on the annular wall of the central diaphragm body or another wall of the central diaphragm body. Preferably, the second solder pad is on a wall of the central diaphragm body that can be accessed after the central diaphragm has been secured to the second suspension element, since this can facilitate connecting the voice coil to the second solder pad during installation. In some examples, the second solder pad is provided on an inner annular wall defining an aperture through the central diaphragm body. For example, the second solder pad may be on a face of the inner annular wall which faces towards the movement axis. Hence, the second solder pad may be reachable through the aperture.

Thus, the central membrane body may be utilised for purposes of signal transmission to and/or from the voice coil, replacing lead wires for part of signal transmission. This may decrease the risk of ticking lead wire noise and may improve installation of lead wires during assembly, which conventionally may be cumbersome and difficult.

An axial extent of the central diaphragm body along the movement axis may be greater than the separation of the landing surfaces along the movement axis.

The first end of the central diaphragm body may have a first extent in a direction perpendicular to the movement axis. The second end of the central diaphragm body may have a second extent in the direction perpendicular to the movement axis. The first extent may be smaller than the second extent.

The first end of the central diaphragm body may be closed. Additionally or alternatively, a dust cap may be located over the first end of the central diaphragm body.

By closing the central diaphragm body, either by providing a closed first end or covering the central diaphragm body with a dust cap, ingress into the loudspeaker may be prevented in part or even entirely.

The loudspeaker as described above may be provided in an enclosure. The enclosure may define an internal volume in a range of 0.25 litres to 5 litres in which the loudspeaker is mounted. In some examples, the internal volume may be up to 1.5 litres.

According to another aspect of the invention. there is provided a bass loudspeaker including: a frame; a diaphragm suspended from the frame by at least a first suspension element and a second suspension element, wherein the first suspension element is attached to the frame at a first landing surface on the frame and the second suspension element is attached to the frame at a second landing surface on the frame; a magnet unit secured to the frame, wherein the magnet unit includes a permanent magnet and at least two flux guiding elements configured to guide magnetic flux across an air gap; a voice coil rigidly connected to the diaphragm; wherein the loudspeaker is operable to energise the voice coil to cause the voice coil to move relative to the magnet unit along a movement axis, thereby moving the diaphragm along the movement axis to produce sound; wherein the diaphragm comprises an outer diaphragm body and a central diaphragm body; wherein the central diaphragm body includes an annular wall which extends around the voice coil, the annular wall extending along the movement axis between a first end and a second end of the central diaphragm body; wherein the outer diaphragm body is connected to the annular wall at a location between the first end and the second end, such that the second end of the annular wall is separated from the location where the outer diaphragm is connected to the annular wall; wherein the first suspension element is connected to the outer diaphragm body; and wherein the second suspension element is connected to the annular wall at or towards the second end of the central diaphragm body.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 is a sectional view of an exemplary loudspeaker.

FIG. 2 is a sectional view of part of the loudspeaker of FIG. 1.

FIG. 3 is a sectional view of part of the loudspeaker of FIG. 1.

FIG. 4 is a graph illustrating magnetic flux lines of the loudspeaker of FIG. 1.

FIG. 5 is a graph illustrating magnetic flux density of the loudspeaker of FIG. 1.

FIG. 6 is a perspective view of a first portion of a diaphragm of the loudspeaker of FIG. 1.

FIG. 7 is a broken-away perspective view of a second portion of a diaphragm of the loudspeaker of FIG. 1.

FIG. 8 is a sectional view of part of the loudspeaker of FIG. 1.

FIG. 9 is a loudspeaker assembly including two loudspeakers of FIG. 1 in back-to-back configuration.

FIG. 10 is a sideview of an automobile with an exemplary loudspeaker.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

The present invention relates to loudspeakers including a frame, a diaphragm and a drive unit. A discussion of examples of traditional loudspeakers follows, for purposes of illustrating the context in which the present invention has been made, before a detailed discussion of the present invention.

In a traditional loudspeaker, the depth of the box is limited by the depth of the loudspeaker itself. There are known loudspeakers that are particularly designed to be shallow, such as those described in EP1654908B1, EP0912072B1, U.S. Pat. No. 7,570,780B2. In EP1654908B1, a loudspeaker is described with an undulated membrane including a V-shaped cone; a lower suspension part is positioned next to a magnet system to decrease rocking motion of a moving assembly of the loudspeaker. In EP0912072B1, a similar loudspeaker is described which uses a tube suspension system. In U.S. Pat. No. 7,570,780B2, yet another loudspeaker is described with a lower suspension adjacent to a magnet system of the loudspeaker.

Each of the aforementioned loudspeakers is configured to provide magnetic flux of approximately uniform flux density across the air gap of the respective loudspeaker. As set out in the background section above, this corresponds to conventional principles of loudspeaker design. It may therefore be a departure from said conventional principles that a loudspeaker is described herein which includes a magnet unit of comparatively non-uniform flux density.

Also, each of the aforementioned loudspeakers makes use of a drive unit with a comparatively small/lightweight voice coil and a comparatively large/heavy, low-reluctance magnetic magnet system. This may also correspond to conventional principles of loudspeaker design. By contrast, the magnet unit of the loudspeaker described herein is relatively lightweight and has a comparatively high reluctance, while the voice coil is comparatively large/heavy.

Compared to the aforementioned known loudspeakers, the loudspeaker described herein may provide a combination of numerous advantages. For example, the loudspeaker described herein is shallow, lightweight and uses a comparatively small amount of rare earth material in the magnet unit. Moreover, it is easy to build with traditional machinery and can be built without increasing the part count compared to a traditional loudspeaker.

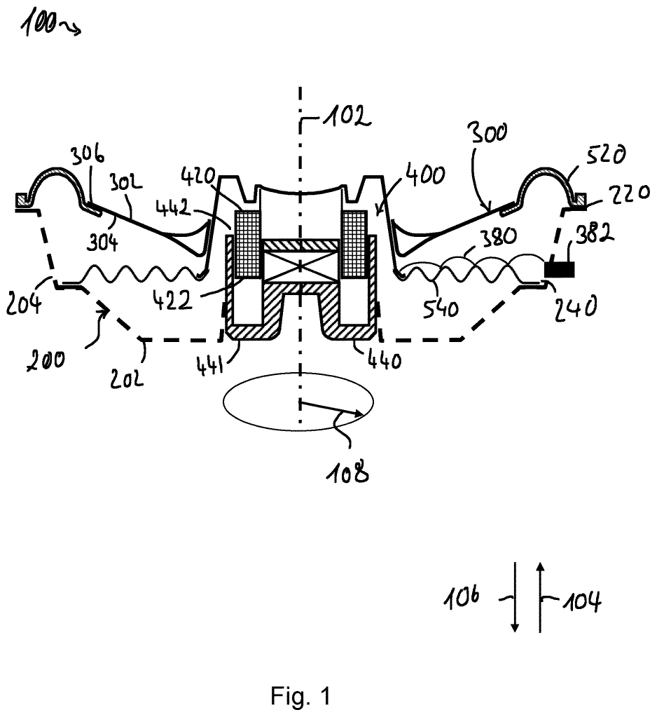

FIG. 1 is a sectional view of an exemplary loudspeaker 100. The loudspeaker 100 includes a frame 200, a diaphragm 300 suspended from the frame 200, and a drive unit 400.

The drive unit 400 has a translatable part 420 and a stationary part 440. The translatable part 420 is secured to the diaphragm 300 and includes a voice coil 422. The stationary part 440 is secured to the frame 200 and includes a magnet unit 441 configured to produce a magnetic field in an air gap 442. When the diaphragm 300 is at rest, the voice coil 422 sits in the air gap 442.

The loudspeaker 100 is operable to energise the voice coil 422 to cause the voice coil 422 to move along the movement axis 102 relative to the magnet unit 441. The voice coil 442 is rigidly connected to the diaphragm 300, such that the voice coil 442 and the diaphragm 300 move together. When causing the voice coil 442 to move along the movement axis 102, the diaphragm 300 also moves along the movement axis 102, thereby producing sound.

More particularly, the diaphragm 300 has a first sound radiating surface 302 and a second sound radiating surface 304. The first sound radiating surface 302 faces in a forward direction 104 (away from the frame 200) and in use is utilised for producing sound. The second sound radiating surface 304 faces in a rearward direction 106, i.e. into the frame 200. The forward direction 104 and the rearward direction 106 are opposite directions parallel to the movement axis 102. A direction perpendicular to the movement axis 102 is also referred to as a radial direction 108.

The frame 200 of the loudspeaker 100 includes a base portion 202 and a rim 204. The base portion 202 extends in the radial direction 108. The rim 204 of the frame 200 is positioned at the periphery of the base portion 202, radially outwardly of the drive unit 400, and extends axially with respect to the movement axis 102, that is at least partly along the movement axis 102.

The stationary part 440 of the drive unit 400 is secured to the base portion 202 of the frame 200 while the diaphragm 300 and the translatable part 420 of the drive unit 400 are suspended from the frame 200 by means of suspension elements 520, 540. The suspension elements 520, 540 are configured to allow movement along the movement axis 102, i.e. in a direction parallel to the movement axis 102, and inhibit movement in the radial direction 108.

A first suspension element 520 is attached to the frame 200 at a first landing surface 220 defined by the rim 204 of the frame 200. The first suspension element 520 is provided as a rubber surround secured to an outer edge 306 of the diaphragm 300. A second suspension element 540 is attached to the frame 200 at a second landing surface 240 defined by the rim 204 of the frame 200. The second suspension element 540 is provided as a damper secured to the diaphragm 300 and extends radially outwardly with respect to the movement axis 102.

The first suspension element 520 and the second suspension element 540 are secured to the diaphragm 300 such that the centre of gravity of the translatable part 420 is located between the first landing surface 220 and the second landing surface 240. More particularly, the voice coil 422 is configured to sit in the air gap 442 when the diaphragm 300 is at rest, with the centre of mass of the voice coil 422 having a position along the movement axis 102 that is between the first landing surface 220 and the second landing surface 240.

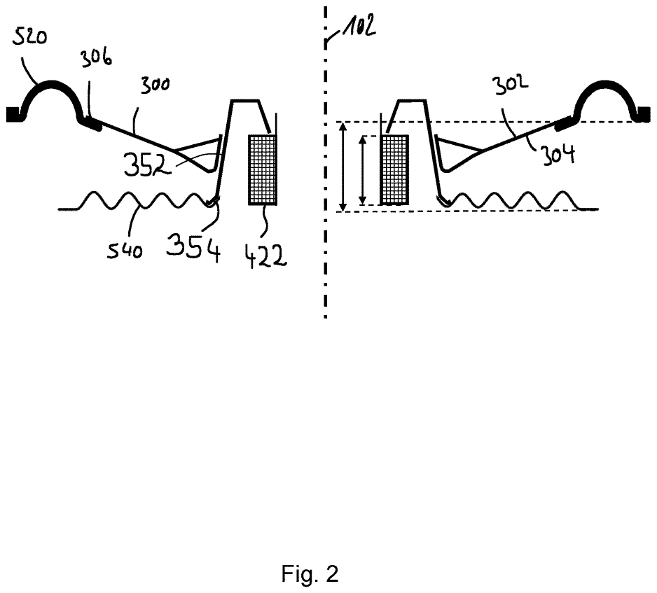

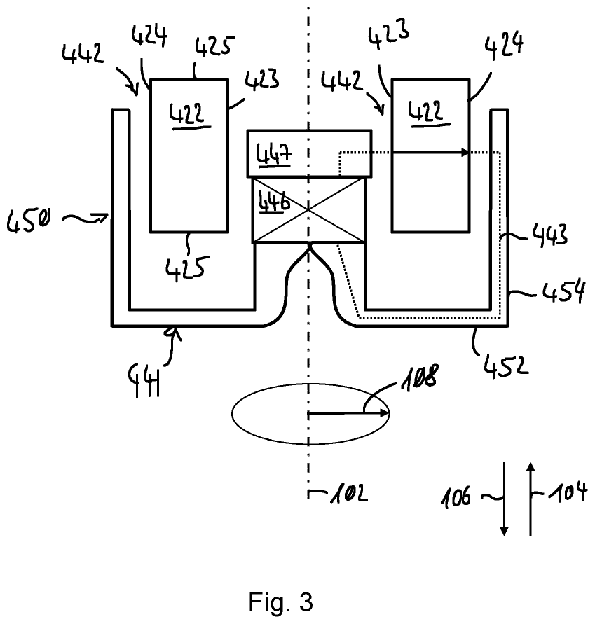

FIGS. 2 and 3 are sectional views of parts of the loudspeaker 100. FIG. 2 shows the diaphragm 300, the voice coil 422, and the suspension elements 520, 540. FIG. 3 shows the voice coil 422 and the magnet unit 441.

The voice coil 422 has an axial extent along the movement axis 102 and a radial extent perpendicular to the movement axis 102. The axial extent of the voice coil 422, which is also known as a height of the voice coil 422, is a distance between a pair of ends 425 of the voice coil 422. The radial extent of the voice coil 422, which is also known as a winding thickness of the voice coil 422, is a distance between an inner perimeter 423 of the voice coil 422 and an outer perimeter 424 of the voice coil 422.

The height of the voice coil 422 is approximately 85% of the separation between the first landing surface 220 and second landing surface 240 as measured in a direction parallel to the movement axis 102.

The magnet unit 441 includes a permanent magnet 446, a (magnetic) washer 447 and a (magnetic) yoke 450. The permanent magnet 446 is provided as a rare earth magnet and may comprise more than one structural element. The permanent magnet 446 has a mass which is smaller than the mass of the voice coil 422. In this example, the mass of the voice coil 422 is greater than the mass of the permanent magnet 446 by a factor of two, i.e. the mass of the voice coil 422 is two times greater than the mass of the permanent magnet 446.

The washer 447 and the yoke 450, which in this example is provided as a U-yoke, are configured to guide the magnetic flux generated by the permanent magnet 446 to the air gap 442 between the washer 447 and the yoke 450. In particular, the washer 447 and the yoke 450 guide the magnetic flux across the air gap 442.

The magnet unit 441 is arranged in the loudspeaker 100 such that the air gap 442 faces in the forward direction 104, and receives the voice coil 422 extending in the rearward direction 106.

The magnet unit 441 and the air gap 442 form a magnetic circuit 443. The magnetic circuit 443 provides a closed loop for the magnetic flux that is generated by the permanent magnet 446 and is guided by the two flux guiding elements 447, 450 across the air gap 442. In this example, the air gap 442 has a magnetic reluctance of 2.0×10\hat{ }6 [1/H] and the magnetic circuit 443 has a total magnetic reluctance slightly greater than the magnetic reluctance of the air gap 442.

The yoke 450 has a base 452 and a sidewall 454 projecting from the base 452. The base 452 extends in the radial direction 108, while the sidewall 454 extends axially with respect to the movement axis 102.

The sidewall 454 of the yoke 450 has a (uniform) thickness bounded radially, i.e. in the radial direction 108. The voice coil 422 also has a (uniform) thickness bounded radially. The thickness of the voice coil 422 is greater than the thickness of the sidewall 454 of the yoke 450. A ratio of the thickness of the voice coil 422, i.e. the winding thickness, over the thickness of the sidewall 454 of 3:1 or even 5:1 is preferred. A traditional speaker of same size may have a ratio as little as 0.2:1.

The loudspeaker 100 makes use of a comparatively large voice coil 422 using many layers in the magnetic circuit 443. As the air gap 442 is wider to accommodate the larger voice coil 442 as compared to a traditional loudspeaker, the total reluctance in the magnetic circuit 443 increases so much that the cross-sections of the flux guiding washer 447 and yoke 450 can be thin.

This new configuration leads to a comparably high voice coil mass and comparatively low magnet unit mass. Yet the overall mass of the drive unit 400 may be lower than, for example, for the aforementioned known loudspeakers. A ratio of moving mass to total mass of up to 1:3, preferably up to 1:2, is possible. Also, a ratio of magnet mass to voice coil winding mass of 1:2, preferably up to 1:4, can be reached. This leads to surprisingly lightweight bass loudspeaker with low resonance frequency in box.

The permanent magnet 446, the washer 447, and the yoke 450 are axially symmetric about the movement axis 102, though other arrangements are possible.

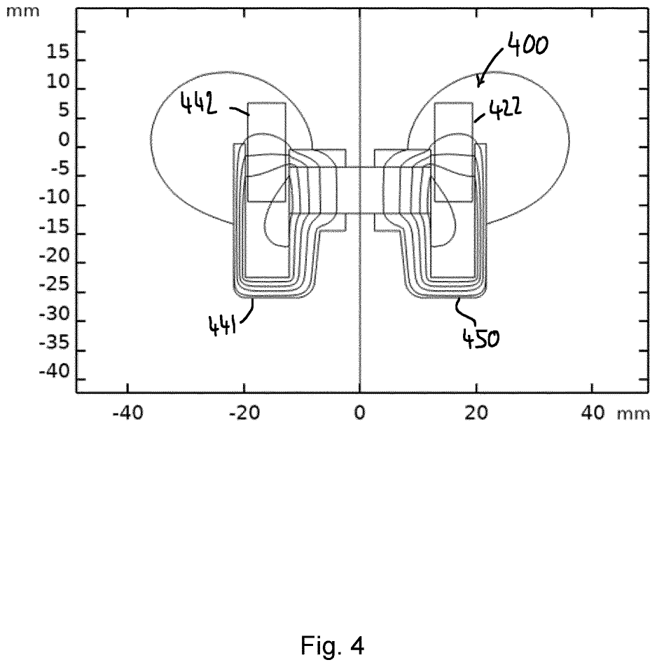

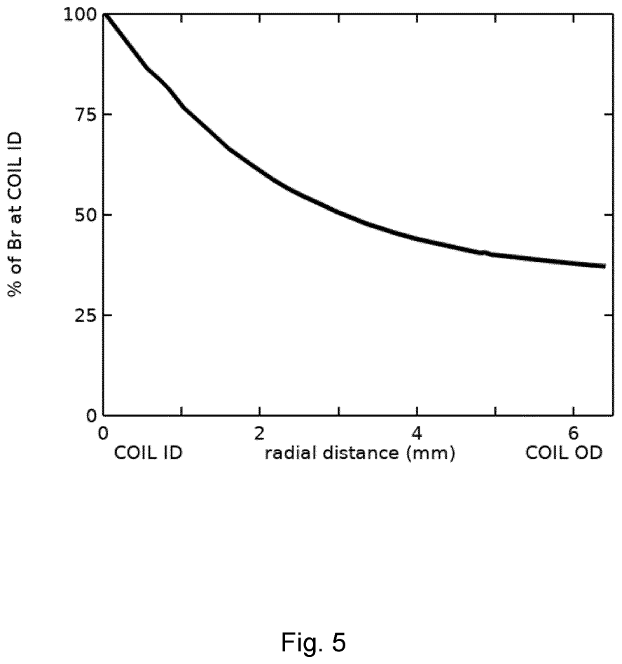

FIGS. 4 and 5 illustrate the magnetic flux generated by the magnet unit 441. In particular, FIG. 4 shows a sectional view of the drive unit 400 and illustrates magnetic flux lines generated by the magnet unit 441, while FIG. 5 is a graph showing the magnetic flux density across the voice coil 422 (“COIL ID” to “COIL OD”, i.e. inner diameter/perimeter 423 to outer diameter/perimeter 424).

In FIG. 4, the magnetic flux follows curved paths spreading out in the air gap 442 across the voice coil 422. Correspondingly, the magnetic flux density decreases across the voice coil 422. FIG. 5 shows the radial flux density Br over the winding thickness of the voice coil 422, which shows a substantial drop typically undesired in loudspeaker design. In a typical loudspeaker the magnetic flux density may be almost constant and may drop to approximately 85 to 90% (percent) of the initial value. By contrast, according to the present invention the radial flux density may drop by at least 50% over the winding thickness of the voice coil 422. In this example, the magnetic flux density at the outer perimeter 424 of the voice coil 422 is approximately 37% of the magnetic flux density at the inner perimeter 423 of the voice coil 422. In other words, the magnetic flux density drops by approximately 63% from the inner perimeter 423 to the outer perimeter 424 of the voice coil 422.

The comparatively large decrease in magnetic flux density is related to the comparatively high reluctance of the magnet unit 441 of the loudspeaker 100. The reluctance can be estimated by calculations derived from simulations using the Finite Element Method of the static magnetic circuit.

The magnetomotive force [symbol] (F_m) of the magnet in the circuit is calculated by multiplying the average magnetic field strength H_{av,m} (H_av,m) inside the magnet times the height of the magnet hₘ (h_m). The resulting unit is Amperes [A].

$${ℱ}_{m} = {H}_{av , m} \cdot {h}_{m} [ A ]$$

The total magnetic flux φ_{B} (Phi_B) through a magnetic circuit is estimated by integration of the magnetic flux density penetrating an open surface. The integration is carried out over a surface Sm (Sm), which is typically a cylindrical surface at the top or bottom surface of the magnet perpendicular to the magnet's magnetization direction. The magnetic flux density at the magnet is strictly axial, such that the radial component can be neglected. The resulting unit is Weber [Wb].

$${ϕ}_{B} = \int {\int }_{B} {B}_{a} \cdot dSm [ Wb ]$$

Dividing the magnetomotive force [symbol] by the magnetic flux φ_{B} yields the reluctance [symbol] (R_m) of the magnetic circuit. The resulting unit is one over Henry [1/H].

$${ℛ}_{m} = \frac{{ℱ}_{m}}{{ϕ}_{B}} [ \frac{1}{H} ]$$

It has been found that having a reluctance above 2.5×10\hat{ }6 [1/H](or “2.5E6 1/H”), preferably above 3×10\hat{ }6 [1/H](or “3E6 1/H”) may lead to highly efficient loudspeakers of low weight. By contrast, carrying out the same calculations on magnet systems of traditional loudspeakers shows that their reluctance may not exceed 1.5×10\hat{ }6 [1/H](or “1.5E6 1/H”).

In this example, the flux guiding elements 447, 450 are made from steel, such that the reluctance of the flux guiding elements can be neglected as the relative permeability μᵣ. of steel is >>1 and all reluctance can be assigned to the air gap 442. Having such a large reluctance air gap 442, the radial flux density is not constant in the air gap 442, as already discussed above.

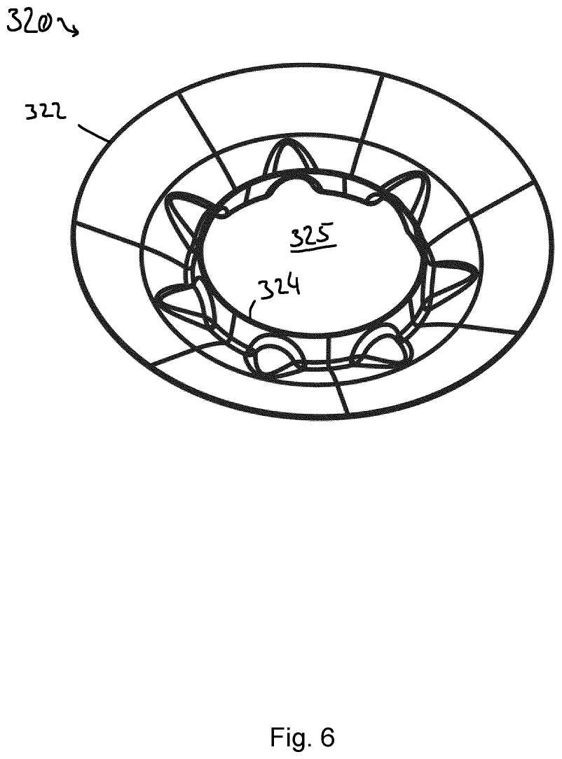

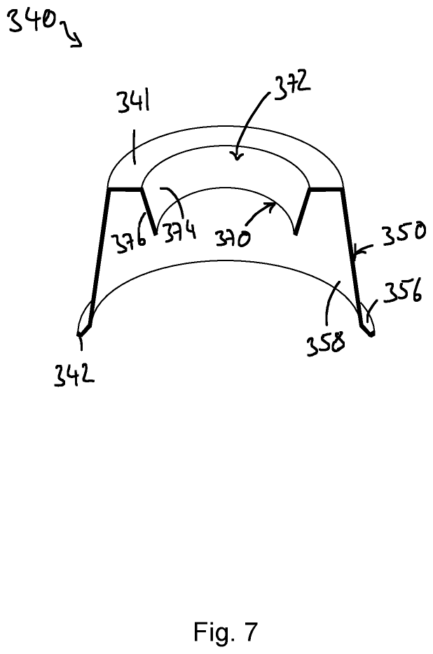

FIGS. 6 and 7 illustrate the diaphragm 300. The diaphragm 300 includes an outer diaphragm body 320 (or ‘cone’) and a central diaphragm body 340 (or ‘sub-cone’).

In FIG. 6, the outer diaphragm body 320 is shown. The outer diaphragm body 320 has an outer edge 322 and an inner edge 324. The inner edge 324 bounds a central aperture 325 through the outer diaphragm body 320. When assembled, the central diaphragm body 340 is received into the central aperture 325.

The outer edge 322 of the outer diaphragm body 320 is connected to the first suspension element 520. In this example, the inner edge 322 of the outer diaphragm body 320 is connected to the central diaphragm body 340 since the diaphragm bodies 320, 340 are formed separately.

The inner edge 324 of the outer diaphragm body 320 is provided at an angle relative to the movement axis 102. In this example, the angle is in the range of 5 degrees to 20 degrees. Thus, an upstanding edge portion at an angle to the movement axis 102 is provided.

In FIG. 7, the central diaphragm body 340 is shown. The central diaphragm body 340 has a forward end 341 and a rearward end 342. The forward end 341 and the rearward end 342 are opposite ends of the central diaphragm body 340 delimiting a lengthwise extent of the central diaphragm body 340. The forward end 341 faces in the forward direction 104 and the rearward end 342 faces in the rearward direction 106.

The central diaphragm body 340 includes an outer annular wall 350 and an inner annular wall 370. The annular walls 350, 370 are concentrically arranged around the movement axis 102. In this example, the inner annular wall 370 and the voice coil 422 are sequentially arranged along the movement axis 102, and the outer annular wall 350 encloses both the inner annular wall 370 and the voice coil 422.

The inner annular wall 370 extends towards the voice coil 422 such that mechanical and/or electrical connection may be made with the voice coil 422 or, where provided, a voice coil former.

The inner annular wall 370 bounds an aperture 372 extending through the central diaphragm body 340.

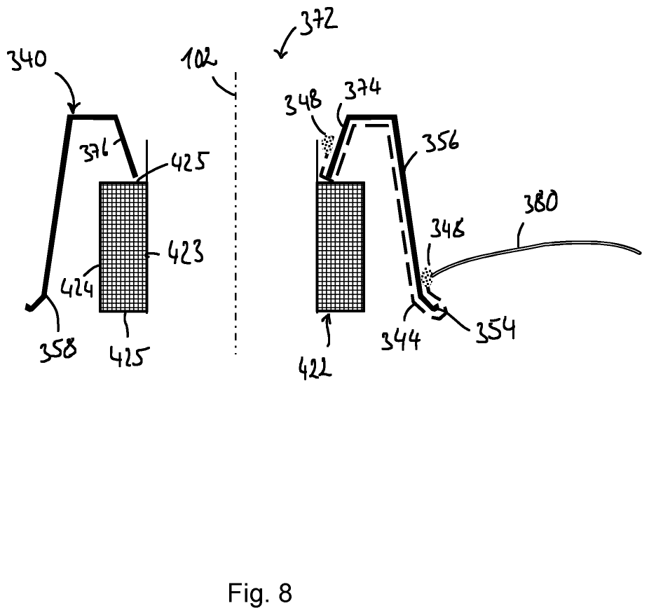

The central diaphragm body 340 and the outer diaphragm body 320 are joined at a location 352 (see FIG. 2) where the outer annular wall 350 receives the outer diaphragm body 320. The location 352 is between the forward end 341 and the rearward end 342 of the central diaphragm body 340. Accordingly, the outer annular wall 350 has a free end 354 (see FIG. 8) in the rearward direction 106. The second suspension element 540 is connected to the outer annular wall 350 and, in particular, the free end 354 of the outer annular wall 350.

The outer annular wall 350 of the central diaphragm body 340 is under a steep angle relative to the movement axis 102. In this example, this angle is in the range of 5 degrees to 20 degrees, allowing for a small inside diameter of the second suspension element 540. This may ensure clearance above the yoke 450, allowing for large axial displacement of the voice coil 422 and the overall moving assembly.

The inner edge 324 of the outer diaphragm body 320 and the outer annular wall 350 of the central diaphragm body 340 are provided at similar steep angles relative to the movement axis 102, e.g. within 3 degrees of each other, as this may improve bonding of the diaphragm bodies 320, 340. Further, this design allows for undulation of the diaphragm 300, resulting in a substantial stiffening of the whole downwards portion of outer diaphragm body 320 and the central diaphragm body 340 while allowing enough clearance to the bottom of the central diaphragm body 340 for leadwire connection.

FIG. 8 shows the central diaphragm body 340 and the voice coil 422. The central diaphragm body 340 is utilised for transmitting a leadwire signal to and from the voice coil 422. More particularly, the central diaphragm body 340 includes a signal track 344, e.g. a copper strip, for guiding a signal to or from the voice coil 422. In practice a minimum of two signal tracks 344 may be provided.

The signal track 344 extends from a radially outer face 356 of the outer annular wall 350 towards the voice coil 422. Suitably, the signal track 344 connects a pair of solder pads 348 for making a connection with a leadwire 380, at one end of the signal track 344, and the voice coil 422, at the other end of the signal track 344. A first solder pad 348 is provided on the radially outer face 356 of the outer annular wall 350, the first solder pad 348 being located towards the rearward end 342. A second solder pad 348 is provided on a radially inner face 374 of the inner annular wall 370.

In this example, the signal track 344 extends along a radially inner face 358 of the outer annular wall 350 and along a radially outer face 376 of the inner annular wall 370.

Utilisation of the signal track 344 may improve ease of assembly of the loudspeaker 100. The signal track 344 may be provided as a thin self-adhesive copper strip glued along the central diaphragm body 340, along the inside or outside of the central diaphragm body 340. This may enable easy connection to the voice coil 422 at the top and to the leadwire 380 at the bottom by means of a solder connection or electrically conductive glue. The flexible leadwires 380 may form an arc through the air or be connected to the second suspension element 340, e.g. by stitching or gluing or even be in-woven.

All electrical connections from the voice coil 422 to the signal track 344, the leadwire 380 and a leadwire terminal 382 may be carried out while the components are easily accessible without the presence of the outer diaphragm body 320 or the need to flip the loudspeaker 100. Electrical connection of the voice 422 may be carried out through the aperture 372 of the central diaphragm body 340.

As for the aforementioned known loudspeakers, it is noted that all three loudspeaker designs may suffer from comparatively complicated guidance of the leadwires connecting the voice coil windings to the terminal. EP0912072B1 allows for large displacement as the inside diameter of the lower suspension is close to the outside diameter of the U-yoke, but the construction and lead wire guidance with the tubular element and coupling feature to the cone may be cumbersome. In the cases of EP1654908B1 and U.S. Pat. No. 7,570,780B2, the part of the membrane that brings the connection surface to the damper next to the U-yoke is under a shallow angle resulting in a large inner diameter of the damper decreasing the maximum excursion capability.

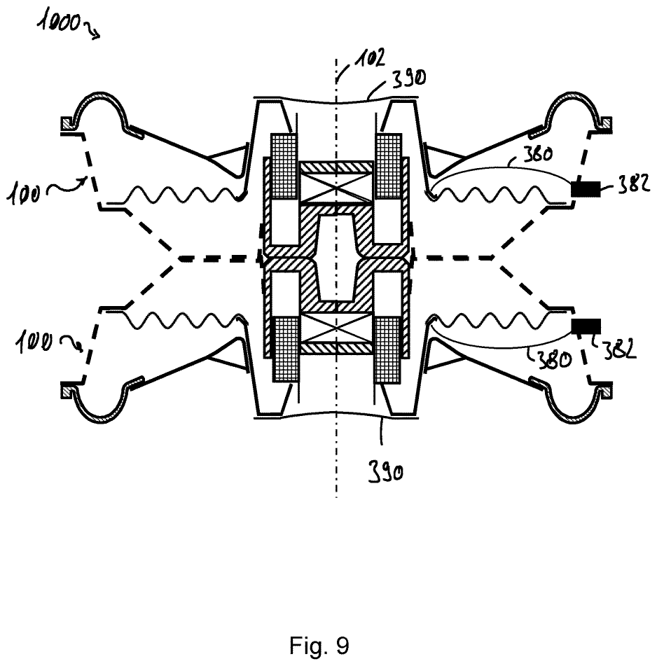

FIG. 9 shows another exemplary loudspeaker 1000. The loudspeaker 1000 includes two loudspeakers 100, as described above, mounted in a back-to-back configuration in a closed box volume of 3 litres, each designed for a nominal stroke of +−10 mm (millimetres). Each loudspeaker 100 is provided as 5-inch woofer for use up to 200 Hz (Hertz) in a closed box of as little as 1.5 litres net volume.

As described above, the magnet unit 441 consists of only three pieces: the U-yoke 450, the permanent magnet 446 (provided as a disc) and the washer 447. The permanent magnet 446 is 24 mm in diameter and 8 mm in height and has a weight of 28 g (grams). This may be exceptionally little for a woofer with this application. The voice coil 422 has 17 mm winding height at a winding thickness of 6.4 mm. The weight of the windings is 75 g. To guide the flux effectively through the windings, the washer 447 has a thickness of 3 mm and the U-yoke has a wall thickness (measured adjacent to half the height of the voice coil windings) of 2 mm. These parameters lead to a ratio of magnet weight to coil weight of 1:2.8. The ratio of winding thickness to U-yoke thickness is 3.15:1.

In FIG. 9, two of these loudspeakers 100 are mounted back-to-back in a closed box of 3 litres total net volume allowing each loudspeaker 100 to act onto a closed volume of 1.5 litres. Due to the small size, the box does not need excessive internal ribbing or stiffening elements which would otherwise increase the necessary outer dimensions and gross volume. The magnet units 441 are mounted back-to-back, mitigating the effect of any leakage flux towards the centre surface where the U-yokes touch, as all flux is forced back into the flux guiding steel allowing the cross section to be minimal.

As the loudspeakers 100 are joined back-to-back, the net force on the rear portion of each individual frame is nil and allows it to be thin and lightweight. The force factor vs displacement of each motor system is symmetric and drops to 50% relative to the rest position at +−8 mm leading to low distortion over a wide displacement range. Having the steel flux guiding elements close to magnetic saturation at approx. 1.6 T allows keeping the inductance so low that it has little influence on the frequency response in the working range up to 200 Hz. In fact, the higher inductance compared to a traditional loudspeaker with fewer windings, and consequently lower inductance, leads to decreased higher order distortions due to the decreasing output for higher frequencies above 200 Hz.

The moving mass of the loudspeaker 100 is approximately 100 g, the sum of the suspension and box stiffness adds up to 15 N/mm resulting in 62 Hz in-box resonance frequency. The total mass of the loudspeaker 100 is below 300 g.

It is worth appreciating the fact that for two drivers back-to-back the total mass of the drivers is below 600 g of which 200 g are moving in opposite directions leading to no net force on the cabinet. The mass of the whole assembly of two drivers in box is below 1.3 kg.

Such small size and weight and absence of any vibration of the cabinet allows placement in positions where the sheer size previously prohibited the application. This can be e.g. close to the bottom of the A-style or between the foot wells in a car cabin in a high power kick-bass application.

One can easily appreciate the possibilities for manufacturing in view of the above disclosure. For example, leadwire guidance with subsequent placement of a dustcap may be improved. In FIG. 9, the loudspeakers 100 are shown with separate dustcaps 390. This may allow a traditional build starting from frame and magnet system and adding the dustcap 390 last. Alternatively, the dustcap is integrated in the central diaphragm body 340 (see FIG. 1) allowing the pre-assembly with the voice coil 422 and installation of the signal track 344 before inserting into the magnet unit and centering via a jig. The diaphragm 300 has a central portion that covers the top of the voice coil and so acting as a dustcap. In this case, the whole loudspeaker may be manufactured around an alignment jig initially inserted into the frame which is finally replaced by the magnet unit. Using this approach, the part count may not increase relative to a traditional loudspeaker while offering substantial benefits in terms of performance, as set out above.

Also shown in FIG. 1 is a leadwire fixed to the second suspension element 540 at multiple locations. One could also imagine the leadwire being partially fixed to the underside of the diaphragm 300 and from there stretching an arc through the air towards the terminal 382. This may decrease the risk of ticking leadwire noise as compared to an arc that starts at the bottom of the central diaphragm body 340.

The voice coil 422 can have one (as described above) or multiple windings being driven from multiple amplifier channels via separate pairs of signal tracks 344 and leadwires 380. Also, the winding wire of the voice coil 422 can have a round cross-section or rectangular cross-section. These winding wire types allow for a higher conductor ratio compared to the volume taken up by the windings (fill factor) and are particularly useful in the described loudspeaker with large coil volume. The winding wire material is any suitable conductor material; preferably Copper but also be Aluminium or a mixture of the two, such as Copper-Clad Aluminium wire.

Both the outer diaphragm body 320 and the central diaphragm body 340 can be made from a material with high heat conductivity (e.g. Aluminium) effectively acting as a heat sink as they are connected proximal to the voice coil 422 without a long voice coil former. In this case, the signal tracks 344 are insulated from the outer diaphragm body 320 and the central diaphragm body 340. One can also imagine soldering one electrical connection to the central diaphragm body 340 and one connection to the outer diaphragm body 320; in this case, electrical insulation between the diaphragm bodies 320, 340 may be provided by the adhesive between them. The leadwires 380 are then also connected to the outer diaphragm body 320 and the central diaphragm body 340, respectively. Of course, also a combination is possible where e.g. only one connection is done via a signal track 344 and the other via an electrically conductive central diaphragm body 340.

In fact, it is also possible to guide the leadouts of the winding wire or the coil along the top surface of the central diaphragm body 340 towards the bottom of the central diaphragm body 340 for connection to the leadwires. This is particularly interesting if the diaphragm 300 has an integrated dustcap and covers the wires completely. The electrical connection along the central diaphragm body 340 can also be carried out by means of an insert moulded conductor in case the central diaphragm body 340 is injection moulded. Even a thin copper layer with only a strip separating the conducting surfaces added to an otherwise insulating central diaphragm body 340 by means of vapor deposition is an option. As one can see, there are many ways to implement the basic concept of the electrical connection being guided along the central diaphragm body 340 and to the inside diameter of the second suspension element 540 and below the diaphragm 300.

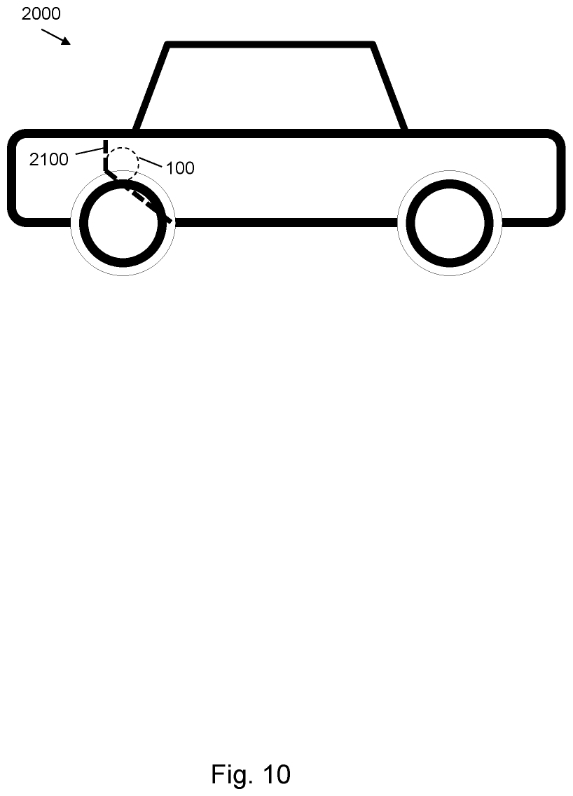

FIG. 10 shows an automobile 2000. Any exemplary loudspeaker as described above may be installed in the automobile 2000. In this example, the loudspeaker 100 described above is provided between the footwells 2100 of the automobile 2000. Other locations are also envisaged, such as at or towards the bottom of an A-style.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### REFERENCES

A number of publications are cited above in order to more fully describe and disclose the invention and the state of the art to which the invention pertains. Full citations for these references are provided below. The entirety of each of these references is incorporated herein.
EP1654908B1
EP0912072B1
U.S. Pat. No. 7,570,780B2

1-16. (canceled)

17. A bass loudspeaker including:
a frame;
a diaphragm suspended from the frame by at least a first suspension element and a second suspension element, wherein the first suspension element is attached to the frame at a first landing surface on the frame and the second suspension element is attached to the frame at a second landing surface on the frame;
a magnet unit secured to the frame, wherein the magnet unit includes a permanent magnet and at least two flux guiding elements configured to guide magnetic flux across an air gap;
a voice coil rigidly connected to the diaphragm;
wherein the loudspeaker is operable to energise the voice coil to cause the voice coil to move relative to the magnet unit along a movement axis, thereby moving the diaphragm along the movement axis to produce sound;
wherein the voice coil is configured to sit in the air gap, with a centre of mass of the voice coil having a position along the movement axis that is between the first landing surface and the second landing surface, when the diaphragm is at rest; and
wherein a magnetic flux density at an outer perimeter of the voice coil is 50% or less of a magnetic flux density at an inner perimeter of the voice coil.

18. The bass loudspeaker according to claim 17, wherein the magnetic flux density at the outer perimeter of the voice coil is in a range of 10% to 50% of the magnetic flux density at the inner perimeter of the voice coil.

19. The bass loudspeaker according to claim 17, wherein the magnet unit and the air gap form a magnetic circuit which has a magnetic reluctance of at least 2.5×10\hat{ }6 [1/H].

20. The bass loudspeaker according to claim 3, wherein the air gap has a magnetic reluctance of at least 2×10\hat{ }6 [1/H].

21. The bass loudspeaker according to claim 17,
wherein the at least two flux guiding elements include a yoke including a base and a sidewall extending from the base,
wherein a thickness of the voice coil in a direction perpendicular to the movement axis is greater than a thickness of the sidewall of the yoke in the direction perpendicular to the movement axis.

22. The bass loudspeaker according to claim 17,
wherein an extent of the voice coil along the movement axis is in a range of 85% and 100% of the separation of the landing surfaces along the movement axis.

23. The bass loudspeaker according to claim 17,
wherein the permanent magnet has a first mass, the voice coil has a second mass, and the first mass is smaller than the second mass.

24. The bass loudspeaker according to claim 17, wherein:
the diaphragm comprises an outer diaphragm body and a central diaphragm body;
the central diaphragm body includes an annular wall which extends around the voice coil, the annular wall extending along the movement axis between a first end and a second end of the central diaphragm body;
wherein the outer diaphragm body is connected to the annular wall at a location between the first end and the second end, such that the second end is separated from the location where the outer diaphragm is connected to the annular wall;
wherein the first suspension element is connected to the outer diaphragm body; and the second suspension element is connected to the annular wall at or towards the second end of the central diaphragm body.

25. The bass loudspeaker according to claim 17, wherein:
the outer diaphragm body has an inner circumferential surface inclined relative to the movement axis,
the annular wall of the central diaphragm body has an outer circumferential surface inclined relative to the movement axis,
wherein the inner circumferential surface and the outer circumferential surface are inclined relative to the movement axis by substantially the same angle and are secured together.

26. The bass loudspeaker according to claim 17, wherein:
wherein the angle is in a range of 3 degrees and 35 degrees relative to the movement axis,
preferably between 3 degrees and 20 degrees relative to the movement axis.

27. The bass loudspeaker according to claim 17, wherein:
the central membrane body includes a signal track to transmit an electrical signal to or from the voice coil;
the signal track extends from a location on the outer circumferential surface of the annular wall, along the annular wall and towards the voice coil,
the location from which the signal track extends is at or towards the second end of the annular wall.

28. The bass loudspeaker according to claim 17,
wherein an axial extent of the central diaphragm body along the movement axis is greater than the separation of the landing surfaces along the movement axis.

29. The bass loudspeaker according to claim 17,
the first end of the central diaphragm body has a first extent in a direction perpendicular to the movement axis,
the second end of the central diaphragm body has a second extent in the direction perpendicular to the movement axis,
the first extent is smaller than the second extent.

30. The bass loudspeaker according to claim 17, wherein:
either the first end of the central diaphragm body is closed,
or a dust cap is located over the first end of the central diaphragm body.

31. An assembly comprising a bass loudspeaker and an enclosure, wherein the bass loudspeaker is mounted in the enclosure, wherein the bass loudspeaker includes:
a frame;
a diaphragm suspended from the frame by at least a first suspension element and a second suspension element, wherein the first suspension element is attached to the frame at a first landing surface on the frame and the second suspension element is attached to the frame at a second landing surface on the frame;
a magnet unit secured to the frame, wherein the magnet unit includes a permanent magnet and at least two flux guiding elements configured to guide magnetic flux across an air gap;
a voice coil rigidly connected to the diaphragm;
wherein the loudspeaker is operable to energise the voice coil to cause the voice coil to move relative to the magnet unit along a movement axis, thereby moving the diaphragm along the movement axis to produce sound;
wherein the voice coil is configured to sit in the air gap, with a centre of mass of the voice coil having a position along the movement axis that is between the first landing surface and the second landing surface, when the diaphragm is at rest; and
wherein a magnetic flux density at an outer perimeter of the voice coil is 50% or less of a magnetic flux density at an inner perimeter of the voice coil.

32. A bass loudspeaker including:
a frame;
a diaphragm suspended from the frame by at least a first suspension element and a second suspension element, wherein the first suspension element is attached to the frame at a first landing surface on the frame and the second suspension element is attached to the frame at a second landing surface on the frame;
a magnet unit secured to the frame, wherein the magnet unit includes a permanent magnet and at least two flux guiding elements configured to guide magnetic flux across an air gap;
a voice coil rigidly connected to the diaphragm;
wherein the loudspeaker is operable to energise the voice coil to cause the voice coil to move relative to the magnet unit along a movement axis, thereby moving the diaphragm along the movement axis to produce sound;
wherein the diaphragm comprises an outer diaphragm body and a central diaphragm body;
wherein the central diaphragm body includes an annular wall which extends around the voice coil, the annular wall extending along the movement axis between a first end and a second end of the central diaphragm body;
wherein the outer diaphragm body is connected to the annular wall at a location between the first end and the second end, such that the second end of the annular wall is separated from the location where the outer diaphragm is connected to the annular wall;
wherein the first suspension element is connected to the outer diaphragm body; and
wherein the second suspension element is connected to the annular wall at or towards the second end of the central diaphragm body.
